(19) United States
(12) Patent Application Publication
(10) Pub. No.: US 2026/0074457 A1
(43) Pub. Date: Mar. 12, 2026

(54) POWER CABLE AND CONDUCTOR ASSEMBLY THEREOF

(71) Applicant: JPC connectivity Inc., New Taipei City (TW)

(72) Inventors: Hsu-Feng CHANG, New Taipei City (TW); Yu-Chai YEH, New Taipei City (TW)

(21) Appl. No.: 18/948,436

(22) Filed: Nov. 14, 2024

(30) Foreign Application Priority Data
Sep. 10, 2024 (TW) 113134213

(51) Int. Cl. H01R 13/24; H01R 13/432; H01R 13/50; H01R 25/14

(52) U.S. Cl. CPC H01R 13/2457; H01R 13/432; H01R 13/50; H01R 25/142

(57) ABSTRACT

A conductor assembly includes: a first conductive piece having a plurality of first terminals and a first rail structure, and the first terminals are parallelly arranged; and a second conductive piece having a plurality of second terminals and a second rail structure, and the second terminals are parallelly arranged. The first conductive piece and the second conductive piece are mutually stacked. The first rail structure and the second rail structure are mutually engaged to guide the first conductive piece and the second constructive piece to relatively move to a predetermined relative position. When the first conductive piece and the second conductive piece are at the predetermined relative position, the first terminals and the second terminals are alternatively arranged. The first and the second conductive pieces are easily assembled through the first and the second rail structures being mutually engaged.

### BACKGROUND OF THE DISCLOSURE

### Technical Field

The present disclosure relates to a connector and a cable assembly, especially to a busbar clamp-type power cable used in an electronic device such as a server and a power storing cabinet.

### Description of Related Art

A related-art busbar clamp-type connector and a cable assembly are mainly used in an electronic device such as a server and a power storing cabinet, a head end thereof is used to clamp a conductive plate and a tail end thereof is used to connect a plurality of power cables to transfer power. The busbar clamp-type connector used in the head end utilizes two clipping terminals oppositely arranged to clamp the conductive plate.

Generally, the terminals of the clamp-type connector are compactly arranged and not easy to be produced. A conductive member used to produce the busbar clamp-type connector separates the terminals to be disposed on two conductive plates, thus the terminals on the two conductive plates are spaced with a greater interval. When the two conductive plates are stacked with each other, each of the terminals of one of the conductive plates is respectively disposed in each interval between the terminals of the other conductive plate. Accordingly, the structure of the related-art clamp-type requires complicate assembling steps.

Accordingly, the applicant of the present disclosure has devoted himself for improving the mentioned shortages.

### SUMMARY OF THE INVENTION

The present disclosure provides a power cable and a conductor assembly thereof, which has rail structures to make the power cable and the conductor assembly be easily assembled.

Accordingly, the present disclosure a conductor assembly, applied in a power cable. The conductor assembly includes a first conductive piece and a second conductive piece. The first conductive piece has a plurality of first terminals and a first rail structure, and the first terminals are parallelly arranged. The second conductive piece has a plurality of second terminals and a second rail structure, and the second terminals are parallelly arranged. The first conductive piece and the second conductive piece are stacked with each other. The first rail structure and the second rail structure are engaged with each other to guide the first conductive piece and the second constructive piece to relatively move to a predetermined relative position. When the first conductive piece and the second conductive piece are at the predetermined relative position, the first terminals and the second terminals are alternatively arranged.

According to one embodiment of the present disclosure, the first rail structure is folded at one side of the first conductive piece, and the second rail structure is formed at an edge defined at one side of the second conductive piece.

According to one embodiment of the present disclosure, the second rail structure is folded at one side of the second conductive piece, and the first rail structure is formed at an edge defined at one side of the first conductive piece.

According to one embodiment of the present disclosure, the first rail structure is a groove disposed on the first conductive piece, and the second rail structure is a tenon disposed on the second conductive piece.

According to one embodiment of the present disclosure, the second rail structure is a groove disposed on the second conductive piece, and the first rail structure is a tenon disposed on the first conductive piece.

According to one embodiment of the present disclosure, a first block part is disposed on the first conductive piece, a second block part is disposed at an edge of the second conductive piece, and the first block part and the second block part are mutually blocked to position the predetermined relative position.

According to one embodiment of the present disclosure, the conductor assembly further includes at least one first conductive wire soldered on the first conductive piece and at least one second conductive wire soldered on the second conductive piece, and the amount of the at least one first conductive wire and the amount of the at least one second conductive wire are different.

Accordingly, the present disclosure further provides a power cable including two engage modules. Each of the engage modules includes an insulation base and a conductor assembly disposed in the insulation base. Each of the insulation bases includes a main body and a tongue part. Each of the conductor assemblies includes a first conductive piece, a second conductive piece and a plurality of terminals. The terminals are exposed at one side of the corresponding tongue part. The terminals include a plurality of first terminals disposed on the first conductive piece and a plurality of second terminals disposed on the second conductive piece. The first terminals are parallelly arranged and the second terminals are parallelly arranged. The first conductive piece includes a first rail structure, and the second conductive piece includes a second rail structure. The first conductive piece and the second conductive piece are stacked with each other. The first rail structure and the second rail structure are engaged with each other to guide the first conductive piece and the second constructive piece to relatively move to a predetermined relative position. When the first conductive piece and the second conductive piece are at the predetermined relative position, the first terminals and the second terminals are alternatively arranged. The two main bodies are mutually connected and the two tongue parts are spaced with an interval to make the terminals of one of the engage modules face the terminals of the other engage module.

According to one embodiment of the present disclosure, in each of the conductor assemblies, the first rail structure is folded at one side of the first conductive piece, and the second rail structure is formed at an edge defined at one side of the second conductive piece.

According to one embodiment of the present disclosure, in each of the conductor assemblies, the second rail structure is folded at one side of the second conductive piece, and the first rail structure is formed at an edge defined at one side of the first conductive piece.

According to one embodiment of the present disclosure, in each of the conductor assemblies, the first rail structure is a groove disposed on the first conductive piece, and the second rail structure is a tenon disposed on the second conductive piece.

According to one embodiment of the present disclosure, in each of the conductor assemblies, the second rail structure is a groove disposed on the second conductive piece, and the first rail structure is a tenon disposed on the first conductive piece.

According to one embodiment of the present disclosure, in each of the conductor assemblies, a first block part is disposed on the first conductive piece, a second block part is disposed at an edge of the second conductive piece, and the first block part and the second block part are mutually blocked to position the predetermined relative position.

According to one embodiment of the present disclosure, each of the engage modules includes at least one first conductive wire soldered on the first conductive piece and at least one second conductive wire soldered on the second conductive piece, and the amount of the at least one first conductive wire and the amount of the at least one second conductive wire are different.

Based on what has been disclosed above, advantages achieved by the present invention are as follows. The first conductive piece and the second conductive piece of the conductor assembly are respectively disposed with the first rail structure and the second rail structure. The first conductive piece and the second conductive piece are facilitated to be easily assembled through the first rail structure and the second rail structure being mutually engaged.

### BRIEF DESCRIPTION OF THE DRAWINGS

FIG. 1 is a perspective view showing the power cable and the engage module thereof according to the first embodiment of the present disclosure;

FIG. 2 is a perspective exploded view showing the power cable and the engage module thereof according to the first embodiment of the present disclosure;

FIG. 3 is a perspective exploded view showing the power cable and the conductor assembly thereof according to the first embodiment of the present disclosure;

FIG. 4 is a longitudinally cross-sectional view showing the power cable according to the first embodiment of the present disclosure;

FIG. 5 is a transversally cross-sectional view showing the power cable and the conductor assembly thereof according to the first embodiment of the present disclosure;

FIG. 6 is a perspective exploded view showing the conductor assembly according to the second embodiment of the present disclosure;

FIG. 7 is a perspective view showing the conductor assembly according to the second embodiment of the present disclosure;

FIG. 8 is a transversally cross-sectional view showing the conductor assembly according to the second embodiment of the present disclosure;

FIG. 9 is a perspective exploded view showing the conductor assembly according to the third embodiment of the present disclosure;

FIG. 10 is a perspective view showing the conductor assembly according to the third embodiment of the present disclosure;

FIG. 11 is a longitudinally cross-sectional view showing the conductor assembly according to the third embodiment of the present disclosure;

FIG. 12 is a perspective exploded view showing the conductor assembly according to the fourth embodiment of the present disclosure;

FIG. 13 is a perspective view showing the conductor assembly according to the fourth embodiment of the present disclosure; and

FIG. 14 is a transversally cross-sectional view showing the conductor assembly according to the fourth embodiment of the present disclosure.

### DETAILED DESCRIPTION

As used in the present disclosure, terms such as “front side”, “rear side”, “left side” “right side”, “front end”, “rear end”, “distal end”, “longitudinal side”, “horizontal side”, “vertical side”, “top end” and “bottom end” are employed to describe various elements, components, regions, layers, and/or parts. These terms should not be construed as limitations on the mentioned elements, components, regions, layers, and/or parts. Instead, they are used merely for distinguishing one element, component, region, layer, or part from another. Unless explicitly indicated in the context, the usage of terms such as “first”, “second”does not imply any specific sequence or order.

Unless being defined otherwise, terms such as “substantial” and “about” are employed to describe and illustrate small variations. When being combined with an incident or a situation, the aforesaid terms may be employed to describe a close point when the incident or the situation is happening and the incident or the situation has developed to a specified level. For example, when being combined with a value, the terms may include, for example a variable range such as smaller than or equal to +/−10% of the value, smaller than or equal to +/−5%, smaller than or equal to +/−4%, smaller than or equal to +/−3%, smaller than or equal to +/−2%, smaller than or equal to +/−1%, smaller than or equal to +/−0.5%, smaller than or equal to +/−0.1% or smaller than or equal to +/−0.05%.

The technical contents of this disclosure will become apparent with the detailed description of embodiments accompanied with the illustration of related drawings as follows. It is intended that the embodiments and drawings disclosed herein are to be considered illustrative rather than restrictive.

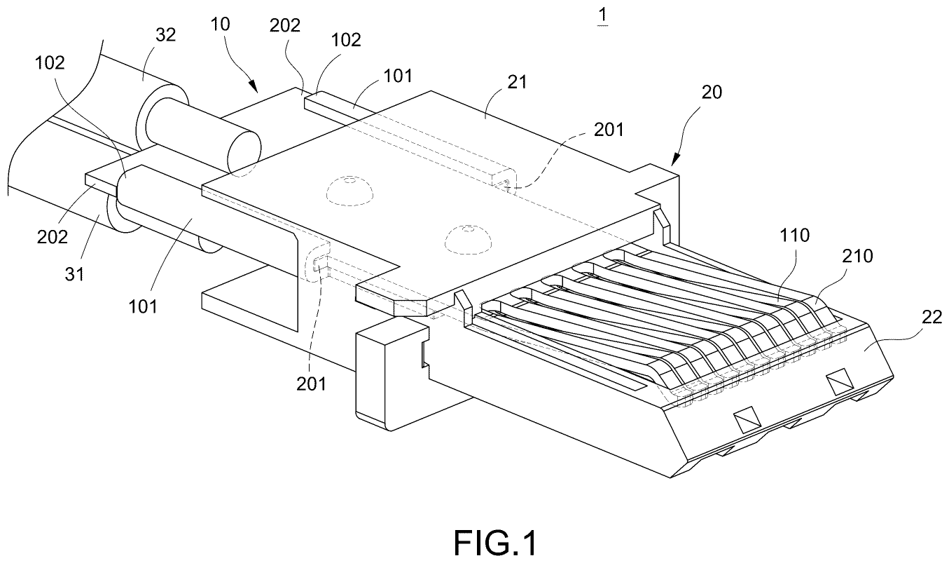

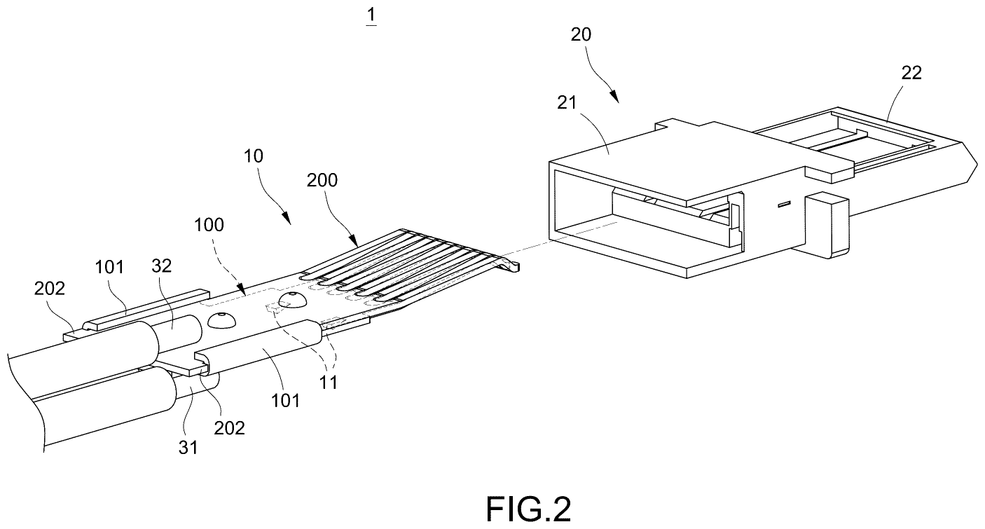

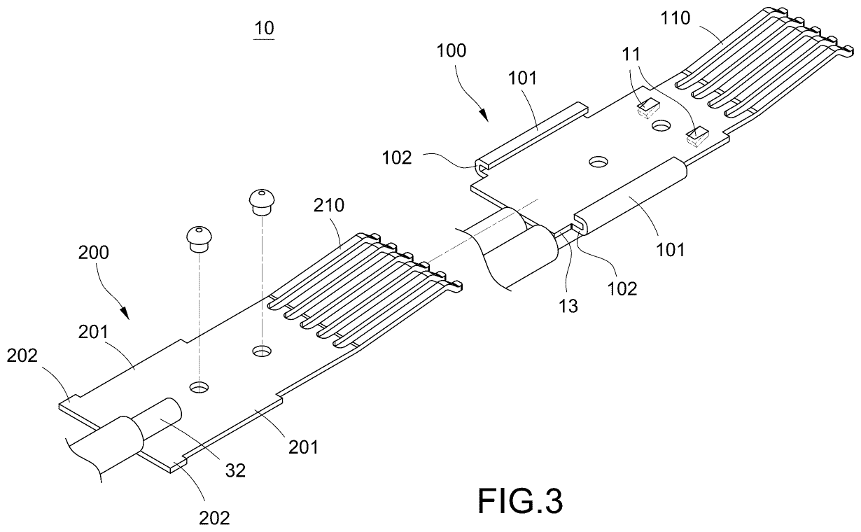

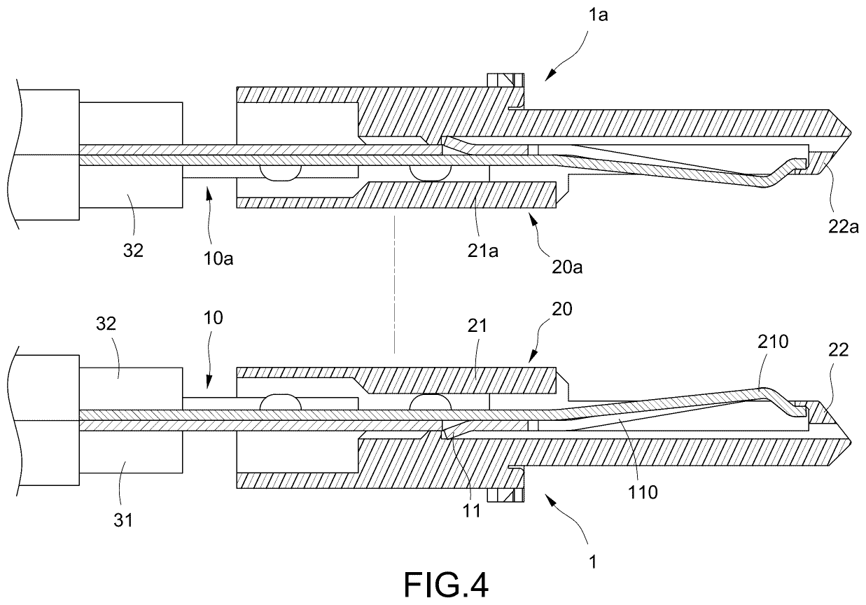

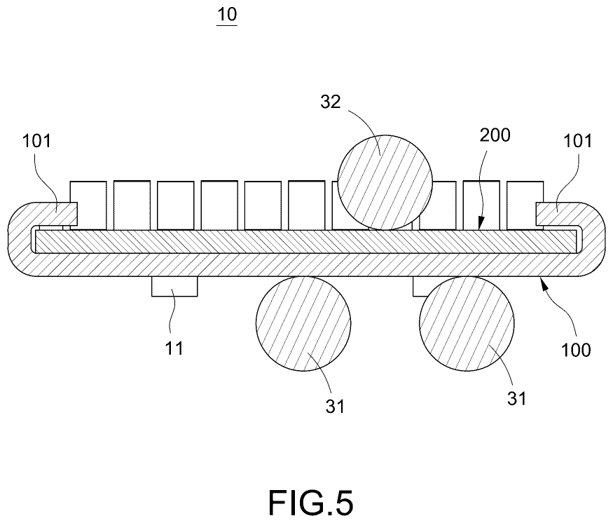

FIG. 1 is a perspective view showing the power cable and the engage module 1 thereof according to the first embodiment of the present disclosure. FIG. 2 is a perspective exploded view showing the power cable and the engage module 1 thereof according to the first embodiment of the present disclosure. FIG. 3 is a perspective exploded view showing the power cable and the conductor assembly 10 thereof according to the first embodiment of the present disclosure. FIG. 4 is a longitudinally cross-sectional view showing the power cable according to the first embodiment of the present disclosure. FIG. 5 is a transversally cross-sectional view showing the power cable and the conductor assembly 10 thereof according to the first embodiment of the present disclosure. Please refer from FIG. 1 to FIG. 5, a power cable is disclosed by the first embodiment of the present disclosure. The power cable includes two engage modules 1, 1a, as shown in FIG. 4. The structures of the two engage modules 1, 1a are configured with a mirror symmetry manner. Each of the engage modules 1, 1a has an insulation base 20, 20a and a conductor assembly 10, 10a disposed in the insulation bases 20, 20a. Each of the insulation bases 20, 20a has a main body 21, 21a and a tongue part 22, 22a. Hereinafter, only the engage module 1 is adopted for illustrating the structure of each of the engage modules 1, 1a.

Please refer to FIG. 1 and FIG. 2, the engage module 1 includes an insulation base 20 and a conductor assembly 10. In the engage module 1, the insulation base 20 is formed in a hollow manner and includes a main body 21 and a tongue part 21. The conductor assembly 10 is disposed in the insulation base 20. According to this embodiment, the conductor assembly 10 has a latching hook 11 to latch an inner wall of the insulation base 20 to make the conductor assembly 10 be fastened in the insulation base 20.

According to the engage module 1 shown in FIG. 2 and the conductor assembly 10 shown in FIG. 3, the conductor assembly 10 includes a first conductive piece 100, a second conductive piece 200 and a plurality of terminals, which are all disposed in the engage module 1. According to this embodiment, the latching hook 11 is disposed on the first conductive piece 100, but here is not intended to be limiting. The terminals are extended in a direction of being parallel to the longitudinal direction of the conductor assembly 10 and exposed at one side of the corresponding tongue part 22. The terminals include a plurality of first terminals 110 disposed on the first conductive piece 100 and a plurality of second terminals 210 disposed on the second conductive piece 200. The first terminals 110 are parallelly arranged on the first conductive piece 100 and the second terminals 210 are parallelly arranged on the second conductive piece 200. The first conductive piece 100 includes at least one first rail structure 101 and the second conductive piece 200 includes at least one second rail structure 201 corresponding to the at least one first rail structure 101. The first conductive piece 100 and the second conductive piece 200 are stacked with each other. The first rail structure 101 and the second rail structure 201 are engaged with each other to guide the first conductive piece 100 and the second constructive piece 200 to relatively move in a direction parallel to the first terminals 110 and the second terminals 210 to a predetermined relative position, as shown in FIG. 2. When the first conductive piece 100 and the second conductive piece 200 are at the predetermined relative position, the first terminals 110 and the second terminals 210 are alternatively arranged.

Please refer to FIG. 3, FIG. 4 and FIG. 5. In each of the conductor assemblies 10 disclosed in this embodiment. The amount of the first rail structure 101 disposed on the first conductive piece 100 is two. The two first rail structures 101 are both disposed at edges of the first conductive piece 100 and oppositely arranged at two sides of the first terminals 110. One of the first rail structures 101 is folded from an edge defined at one side of the first conductive piece 100. The other first rail structure 101 is folded from an edge defined at an opposite side of the first conductive piece 100. The amount of the second rail structure 201 disposed at edges of the second conductive piece 200 is two. The two second rail structures 201 are oppositely arranged at two sides of the second terminals 210. Each of the first rail structures 101 is arranged with a manner of being parallel to the first terminals 110. Each of the second rail structures 201 is arranged with a manner of being parallel to the second terminals 210.

The first rail structure 101 and the second rail structure 201 are respectively formed on the first conductive piece 100 and the second conductive piece 200 with a punching manner. The first conductive piece 100 and the second conductive piece 200 are facilitated to be easily produced and assembled through the first rail structure 101 and the second rail structure 201 being mutually engaged.

In each of the conductor assemblies 10, a first block part 102 is disposed on the first conductive piece 100. A second block part 202 is disposed at an edge of the second conductive piece 200. The first block part 102 and the second block part 202 are mutually blocked along a longitudinal direction relative to the first conductive piece 100 and the second conductive piece 200 to position the predetermined relative position. According to this embodiment, the first block part 102 is formed at one end of each of the first rail structures 101. The second block part 202 is formed at an edge of the second conductive piece 200 with a manner of being protruded from one end of each of the corresponding second rail structures 201.

The engage module 1 includes at least one first conductive wire 31 soldered on the first conductive piece 100 and at least one second conductive wire 32 soldered on the second conductive piece 200. The amount of the at least one first conductive wire 31 and the amount of the at least one second conductive wire 32 are different. According to this embodiment, the amount of the first conductive wire 31 soldered on the first conductive piece 100 is two and the amount of the second conductive wire 32 soldered on the second conductive piece 200 is one.

Please refer to FIG. 4, the two main bodies 21, 21a are mutually connected and the two tongue parts 22, 22a are spaced apart to make the terminals of one of the engage modules 1 face the terminals of the other engage module 1a, and the second conductive wires 32 of the two engage modules 1, 1a are arranged to face each other.

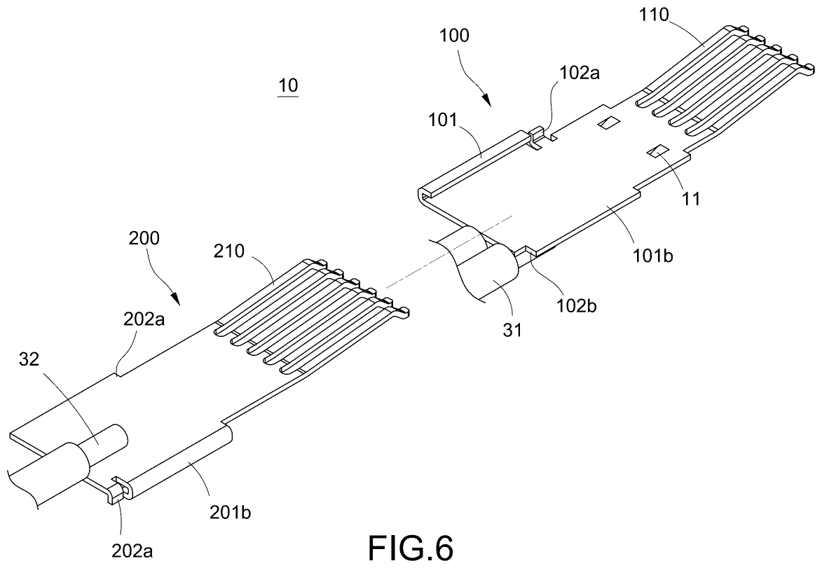

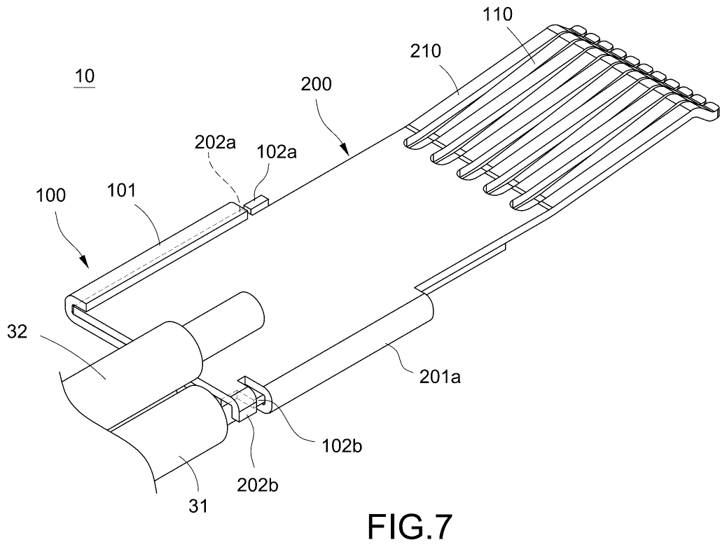

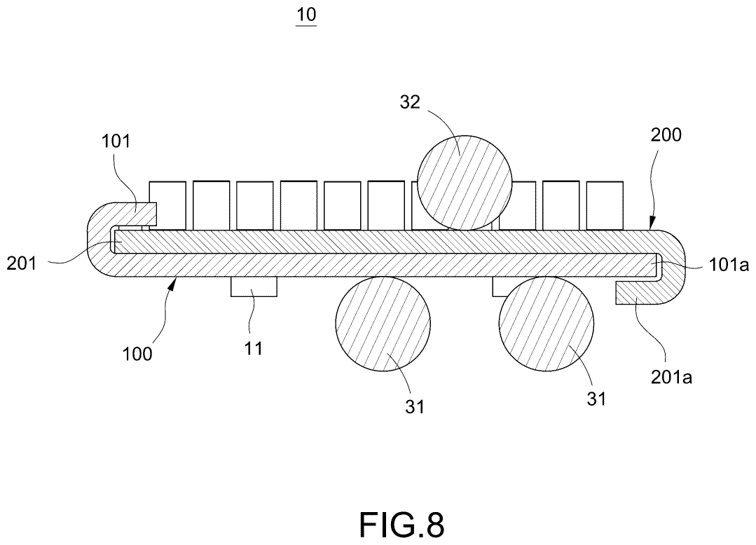

FIG. 6 is a perspective exploded view showing the conductor assembly 10 according to the second embodiment of the present disclosure. FIG. 7 is a perspective view showing the conductor assembly 10 according to the second embodiment of the present disclosure. FIG. 8 is a transversally cross-sectional view showing the conductor assembly 10 according to the second embodiment of the present disclosure. Please refer from FIG. 6 to FIG. 8, a conductor assembly 10 is disclosed in the second embodiment of the present disclosure. The conductor assembly 10 is applied to the aforesaid power cable and disposed in the aforesaid insulation base 20. According to this embodiment, the conductor assembly 10 includes a first conductive piece 100, a second conductive piece 200 and a plurality of terminals. The terminals are exposed at one side of the corresponding tongue part 22. The terminals include a plurality of first terminals 110 disposed on the first conductive piece 100 and a plurality of second terminals 210 disposed on the second conductive piece 200. The first terminals 110 are parallelly arranged and the second terminals 210 are parallelly arranged. The first conductive piece 100 includes at least one first rail structure 101, 101a and the second conductive piece 200 includes at least one second rail structure 201, 201a corresponding to the at least one first rail structure 101, 101a. The first conductive piece 100 and the second conductive piece 200 are stacked with each other. The first rail structure 101, 101a and the second rail structure 201, 201a are engaged with each other to guide the first conductive piece 100 and the second constructive piece 200 to relatively move in a direction parallel to the first terminals 110 and the second terminals 210 to a predetermined relative position. When the first conductive piece 100 and the second conductive piece 200 are at the predetermined relative position, the first terminals 110 and the second terminals 210 are alternatively arranged. As such, the first conductive piece 100 and the second conductive piece 200 are facilitated to be easily assembled through the first rail structure 101, 101a and the second rail structure 201, 201a being mutually engaged.

The second embodiment is substantially the same as the first embodiment. One of the first rail structures 101 is folded from one side of the first conductive piece 100. One of the second rail structures 201 is formed at an edge defined at one side of the corresponding second conductive piece 200. The differences between the second embodiment and the first embodiment are as follows. The other second rail structure 201a is folded from another side of the second conductive piece 200, and the other corresponding first rail structures 101a is formed at an edge defined at one side of the first conductive piece 100.

According to this embodiment, at least one first block part 102a, 102b is disposed on the first conductive piece 100. At least one second block part 202a, 202b is disposed at an edge of the second conductive piece 200 corresponding to the at least one first block part 102a, 102b. The first block part 102a, 102b and the second block part 202a, 202b are mutually blocked to position the predetermined relative position. According to this embodiment, one end of the first rail structure 101 correspondingly folded on the first conductive piece 100 is partially bent to form the first block part 102b to block the second rail structure 201a formed at an edge of the second conductive piece 200. One end of the second rail structure 201a correspondingly folded on the second conductive piece 200 is partially bent to form the second block part 202a to block the first rail structure 102a formed at an edge of the first conductive piece 100.

According to this embodiment, the conductor assembly 10 further includes at least one first conductive wire 31 soldered on the first conductive piece 100 and at least one second conductive wire 32 soldered on the second conductive piece 200. The amount of the at least one first conductive wire 31 and the amount of the at least one second conductive wire 32 are different. In this embodiment, the amount of the first conductive wire 31 soldered on the first conductive piece 100 is two and the amount of the second conductive wire 32 soldered on the second conductive piece 200 is one.

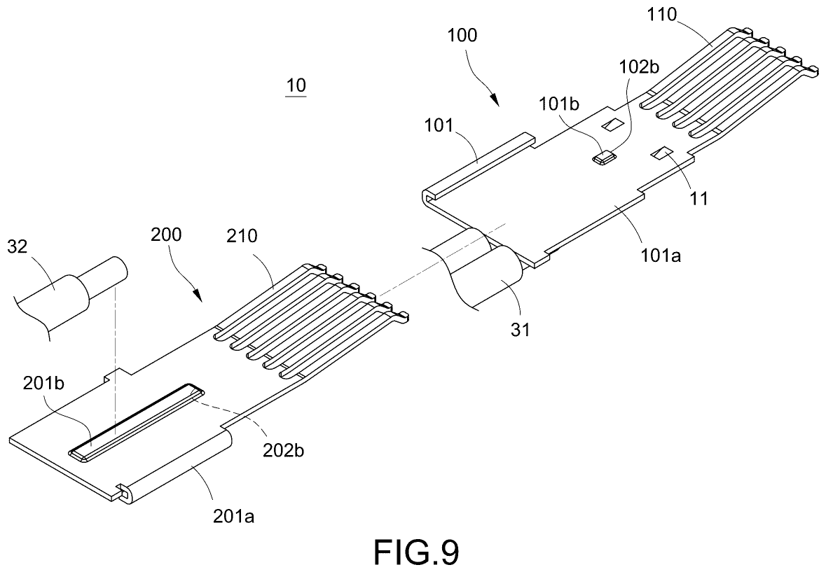

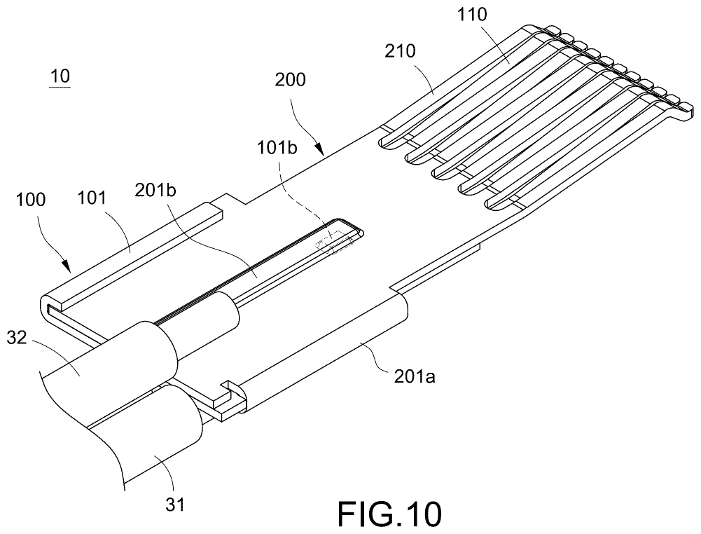

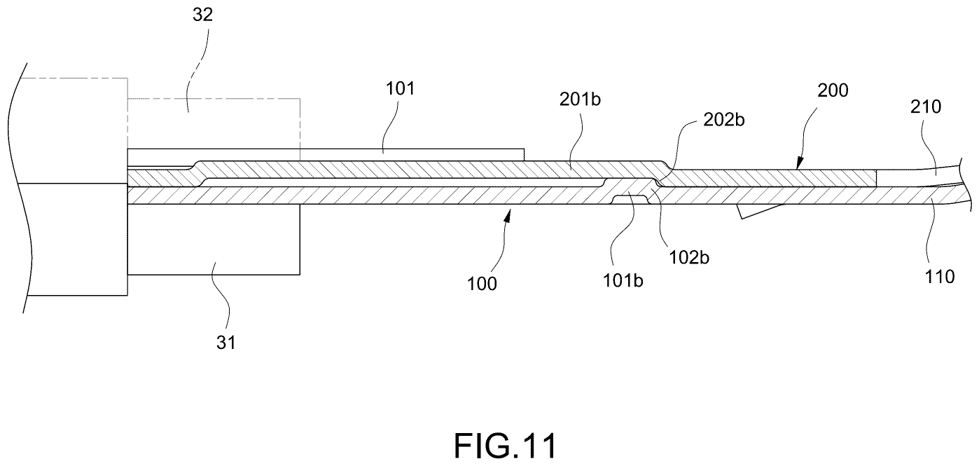

FIG. 9 is a perspective exploded view showing the conductor assembly 10 according to the third embodiment of the present disclosure. FIG. 10 is a perspective view showing the conductor assembly 10 according to the third embodiment of the present disclosure. FIG. 11 is a longitudinally cross-sectional view showing the conductor assembly 10 according to the third embodiment of the present disclosure. Please refer from FIG. 9 to FIG. 11, a conductor assembly 10 is disclosed in the third embodiment of the present disclosure. The conductor assembly 10 is applied to the aforesaid power cable and disposed in the aforesaid insulation base 20. According to this embodiment, the conductor assembly 10 includes a first conductive piece 200 and a second conductive piece 200. The first conductive piece 100 includes a plurality of first terminals 110 and a first rail structure 101, and the first terminals 110 are parallelly arranged. The second conductive piece 200 includes a plurality of second terminals 210 and a second rail structure 201, and the second terminals 210 are parallelly arranged. The first conductive piece 100 and the second conductive piece 200 are stacked with each other. The first rail structure 101 and the second rail structure 201 are engaged with each other to guide the first conductive piece 100 and the second constructive piece 200 to relatively move in a direction parallel to the first terminals 110 and the second terminals 210 to a predetermined relative position. When the first conductive piece 100 and the second conductive piece 200 are at the predetermined relative position, the first terminals 110 and the second terminals 210 are alternatively arranged.

The structure disclosed in the third embodiment is substantially the same as the structure disclosed in the second embodiment, therefore no further illustration is provided. The differences between the third embodiment and the second embodiment are as follows. Another first rail structure 101b in a different type is provided. According to this embodiment, the first rail structure 101b is a tenon disposed on the first conductive piece 100, and a second rail structure 201b corresponding to the first block part 101b is a groove disposed on the second conductive piece 200. Substantially, the second rail structure 201b is in a blind groove.

According to this embodiment, a first block part 102b in a different type is disposed on the first conductive piece 100. A second block part 202b corresponding to the first block part 102b is disposed at an edge of the second conductive piece 200. The first block part 102b and the second block part 202b are mutually blocked to position the predetermined relative position. In this embodiment, the second block part 202b is formed at an inner edge defined at one end of the groove, and the corresponding first block part 102b is formed at one side of the tenon.

According to this embodiment, the conductor assembly 10 further includes at least one first conductive wire 31 soldered on the first conductive piece 100 and at least one second conductive wire 32 soldered on the second conductive piece 200. The amount of the at least one first conductive wire 31 and the amount of the at least one second conductive wire 32 are different. In this embodiment, the amount of the first conductive wire 31 soldered on the first conductive piece 100 is two and the amount of the second conductive wire 32 soldered on the second conductive piece 200 is one.

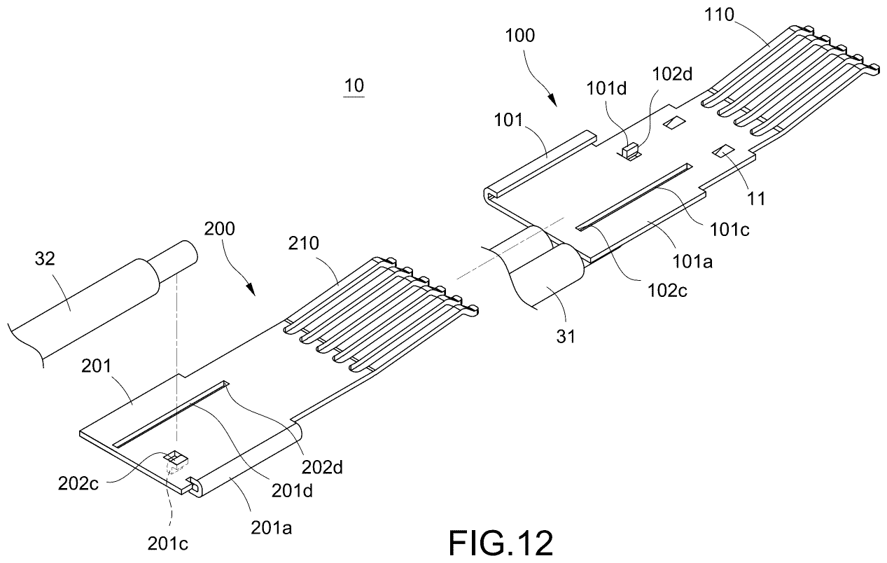

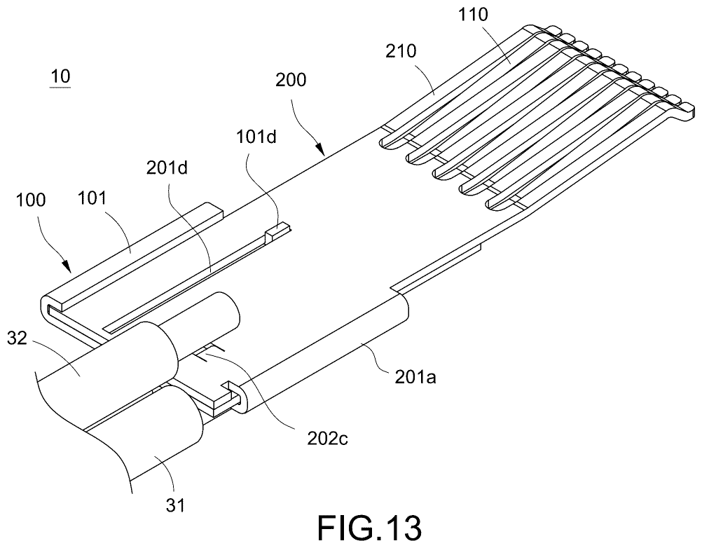

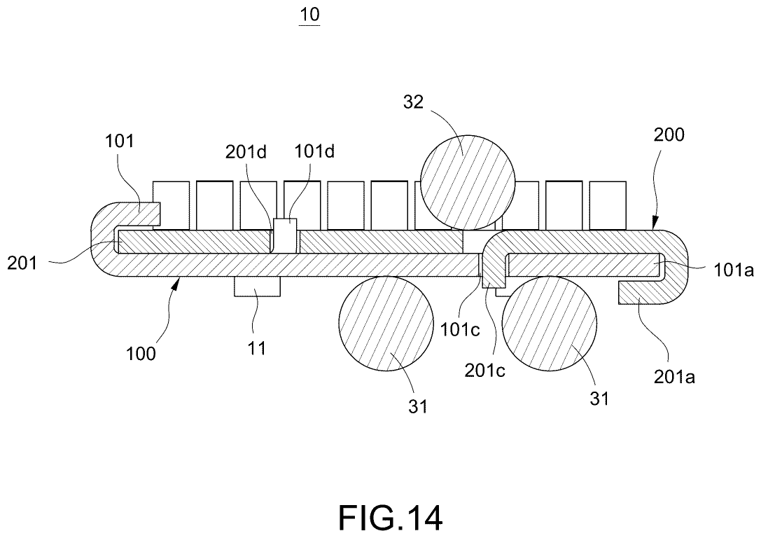

FIG. 12 is a perspective exploded view showing the conductor assembly 10 according to the fourth embodiment of the present disclosure. FIG. 13 is a perspective view showing the conductor assembly 10 according to the fourth embodiment of the present disclosure. FIG. 14 is a transversally cross-sectional view showing the conductor assembly 10 according to the fourth embodiment of the present disclosure. Please refer from FIG. 12 to FIG. 14, a conductor assembly 10 is disclosed in the fourth embodiment of the present disclosure. The conductor assembly 10 is applied to the aforesaid power cable and disposed in the aforesaid insulation base 20. According to this embodiment, the conductor assembly 10 includes a first conductive piece 100, a second conductive piece 200 and a plurality of terminals. The terminals are exposed at one side of the corresponding tongue part 22. The terminals include a plurality of first terminals 110 disposed on the first conductive piece 100 and a plurality of second terminals 210 disposed on the second conductive piece 200. The first terminals 110 are parallelly arranged and the second terminals 210 are parallelly arranged. The first conductive piece 100 includes a first rail structure 101 and the second conductive piece 200 includes a second rail structure 201. The first conductive piece 100 and the second conductive piece 200 are stacked with each other. The first rail structure 101 and the second rail structure 201 are engaged with each other to guide the first conductive piece 100 and the second constructive piece 200 to relatively move in a direction parallel to the first terminals 110 and the second terminals 210 to a predetermined relative position. When the first conductive piece 100 and the second conductive piece 200 are at the predetermined relative position, the first terminals 110 and the second terminals 210 are alternatively arranged. As such, the first conductive piece 100 and the second conductive piece 200 are facilitated to be easily assembled through the first rail structure 101 and the second rail structure 201 being mutually engaged.

The structure disclosed in the fourth embodiment is substantially the same as the structure disclosed in the second embodiment, therefore no further illustration is provided. The difference between the fourth embodiment and the second embodiment is as follows. Another first rail structure 101c in a different type is provided. The first rail structure 101c is a groove disposed on the first conductive piece 100, and a second rail structure 201c corresponding to the first rail structure 101c is a tenon disposed on the second conductive piece 200. Substantially, the first rail structure 101c is a penetrated groove. In this embodiment, another second rail structure 201d disposed on the second conductive piece 200 is a groove, and a first rail structure 101d corresponding to the second rail structure 201d is a tenon disposed on the first conductive piece 100. The second rail structure 201d is a penetrated groove.

According to this embodiment, a first block part 102c, 102d in a different type is disposed on the first conductive piece 100. A second block part 202c, 202d corresponding to the first block part 102c, 102d is disposed at an edge of the second conductive piece 200. The first block part 102c, 102d and the second block part 202c, 202d are mutually blocked to position the predetermined relative position. In this embodiment, the first block part 102c is formed at an inner edge defined at one end of the groove of the first conductive piece 100, and the corresponding second block part 202c is formed at one side of the corresponding tenon. The second block part 202d is formed at an inner edge defined at one end of the groove of the second conductive piece 200, and the corresponding first block part 102d is formed at one side of the corresponding tenon.

According to this embodiment, the conductor assembly 10 further includes at least one first conductive wire 31 soldered on the first conductive piece 100 and at least one second conductive wire 32 soldered on the second conductive piece 200. The amount of the at least one first conductive wire 31 and the amount of the at least one second conductive wire 32 are different. In this embodiment, the amount of the first conductive wire 31 soldered on the first conductive piece 100 is two and the amount of the second conductive wire 32 soldered on the second conductive piece 200 is one.

Accordingly, the first conductive piece 100 and the second conductive piece 200 of the conductor assembly 10 disclosed in the present disclosure are respectively disposed with the first rail structure 101, 101a, 101b, 101c, 101d and the second rail structure 201, 201a, 201b, 201c, 201d. The first conductive piece 100 and the second conductive piece 200 are facilitated to be easily assembled through the first rail structure 101, 101a, 101b, 101c, 101d and the second rail structure 201, 201a, 201b, 201c, 201d being mutually engaged. The first rail structure 101, 101a, 101b, 101c, 101d and the second rail structure 201, 201a, 201b, 201c, 201d are respectively formed on the first conductive piece 100 and the second conductive piece 200 with a punching manner to be easily produced.

While this disclosure has been described by means of specific embodiments, numerous modifications and variations may be made thereto by those skilled in the art without departing from the scope and spirit of this disclosure set forth in the claims.

What is claimed is:

1. A conductor assembly, applied in a power cable, and the conductor assembly comprising:
a first conductive piece, comprising a plurality of first terminals and a first rail structure, wherein the first terminals are parallelly arranged; and
a second conductive piece, comprising a plurality of second terminals and a second rail structure, wherein the second terminals are parallelly arranged;
wherein the first conductive piece and the second conductive piece are stacked with each other, the first rail structure and the second rail structure are engaged with each other to guide the first conductive piece and the second constructive piece to relatively move to a predetermined relative position; when the first conductive piece and the second conductive piece are at the predetermined relative position, the first terminals and the second terminals are alternatively arranged.

2. The conductor assembly according to claim 1, wherein the first rail structure is folded from one side of the first conductive piece, and the second rail structure is disposed on one side of the second conductive piece.

3. The conductor assembly according to claim 1, wherein the second rail structure is folded from one side of the second conductive piece, and the first rail structures is disposed on one side of the first conductive piece.

4. The conductor assembly according to claim 1, wherein the first rail structure is a groove defined on the first conductive piece, and the second rail structure is a tenon disposed on the second conductive piece.

5. The conductor assembly according to claim 1, wherein the second rail structure is a groove defined on the second conductive piece, and the first rail structure is a tenon disposed on the first conductive piece.

6. The conductor assembly according to claim 1, wherein a first block part is disposed on the first conductive piece, a second block part is disposed on the second conductive piece, and the first block part and the second block part are mutually blocked to position the predetermined relative position.

7. The conductor assembly according to claim 1, further comprising at least one first conductive wire soldered on the first conductive piece and at least one second conductive wire soldered on the second conductive piece, and an amount of the at least one first conductive wire and an amount of the at least one second conductive wire are different.

8. A power cable, comprising:
two engage modules, respectively comprising an insulation base and a conductor assembly disposed in the insulation base;
wherein the insulation bases comprise a main body and a tongue part;
wherein the conductor assembly comprises a first conductive piece, a second conductive piece and a plurality of terminals, the terminals are exposed from one side of the tongue part correspondingly, the terminals comprise a plurality of first terminals disposed on the first conductive piece and a plurality of second terminals disposed on the second conductive piece, the first terminals are parallelly arranged, the second terminals are parallelly arranged, the first conductive piece comprises a first rail structure, and the second conductive piece comprises a second rail structure, the first conductive piece and the second conductive piece are stacked with each other, the first rail structure and the second rail structure are engaged with each other to guide the first conductive piece and the second constructive piece to relatively move to a predetermined relative position, when the first conductive piece and the second conductive piece are at the predetermined relative position, the first terminals and the second terminals are alternatively arranged;
wherein two main bodies are mutually connected and two tongue parts are disposed spacedly to make the terminals of one of the engage modules face the terminals of another one of the engage modules.

9. The power cable according to claim 8, wherein in the conductor assembly, the first rail structure is folded from one side of the first conductive piece, and the second rail structure is disposed on one side of the second conductive piece.

10. The power cable according to claim 8, wherein in the conductor assembly, the second rail structure is folded from one side of the second conductive piece, and the first rail structure is disposed on one side of the first conductive piece.

11. The power cable according to claim 8, wherein in the conductor assembly, the first rail structure is a groove defined on the first conductive piece, and the second rail structure is a tenon disposed on the second conductive piece.

12. The power cable according to claim 8, wherein in the conductor assembly, the second rail structure is a groove defined on the second conductive piece, and the first rail structure is a tenon disposed on the first conductive piece.

13. The power cable according to claim 8, wherein in the conductor assembly, a first block part is disposed on the first conductive piece, a second block part is disposed on the second conductive piece, and the first block part and the second block part are mutually blocked to position the predetermined relative position.

14. The power cable according to claim 8, wherein each of the engage modules comprises at least one first conductive wire soldered on the first conductive piece and at least one second conductive wire soldered on the second conductive piece, and an amount of the at least one first conductive wire and an amount of the at least one second conductive wire are different.
